(19) United States
(12) Patent Application Publication
(10) Pub. No.: US 2017/0008806 A1
(43) Pub. Date: Jan. 12, 2017

(54) DIELECTRIC CERAMIC COMPOSITION AND MULTILAYER CERAMIC CAPACITOR CONTAINING THE SAME

(71) Applicant: SAMSUNG ELECTRO-MECHANICS CO., LTD., Suwon-si (KR)

(72) Inventors: Seok Hyun YOON, Suwon-si (KR); Yun Jung PARK, Suwon-si (KR); Song Je JEON, Suwon-si (KR); Chang Hoon KIM, Suwon-si (KR); Soo Kyong JO, Suwon-si (KR)

(21) Appl. No.: 15/047,263

(22) Filed: Feb. 18, 2016

(30) Foreign Application Priority Data
Jul. 6, 2015 (KR) 10-2015-0095992

(51) Int. Cl. C04B 35/49; H01G 4/248; H01G 4/012; H01G 4/12; H01G 4/30

(52) U.S. Cl. CPC C04B 35/49; H01G 4/1209; H01G 4/30; H01G 4/012; H01G 4/248; C04B 2235/3249; C04B 2235/3267; C04B 2235/3239; C04B 2235/3225; C04B 2235/3224; C04B 2235/3418

(57) ABSTRACT

There are provided a dielectric ceramic composition and a multilayer ceramic capacitor containing the same. The dielectric ceramic composition may contain a base material powder represented by (Ca₁₋ₓSrₓ)(Zr_{1-y}Ti_{y})O₃ (0≦x≦1.0 and 0.3≦y≦0.8). A multilayer ceramic capacitor may include a ceramic body in which dielectric layers and first and second internal electrodes are alternately stacked, wherein the dielectric layers contain a dielectric ceramic composition containing a base material powder represented by (Ca₁₋ₓSrₓ)(Zr_{1-y}Ti_{y})O₃ (0≦x≦1.0 and 0.3≦y≦0.8).

### CROSS-REFERENCE TO RELATED APPLICATION

This application claims the priority and benefit of Korean Patent Application No. 10-2015-0095992 filed on Jul. 6, 2015, with the Korean Intellectual Property Office, the disclosure of which is incorporated herein by reference.

### TECHNICAL FIELD

The present disclosure relates to a high-permittivity dielectric ceramic composition, a permittivity of which is not changed when a direct current (DC) electric field is applied thereto, and a multilayer ceramic capacitor (MLCC) containing the same.

### BACKGROUND

In general, electronic components using ceramic materials, such as capacitors, inductors, piezoelectric elements, varistors, or thermistors, and the like, include a ceramic body formed of a ceramic material, internal electrodes formed in the ceramic body, and external electrodes mounted on a surface or surfaces of the ceramic body to be connected to the internal electrodes.

Among ceramic electronic components, a multilayer ceramic capacitor includes a plurality of stacked dielectric layers, internal electrodes disposed to face each other with respective dielectric layers interposed therebetween, and external electrodes electrically connected to the internal electrodes.

A barium titanate (BaTiO₃)-based ferroelectric material, a dielectric material used in a multilayer ceramic capacitor according to the related art, has high permittivity at room temperature, a relatively low dissipation factor, and excellent insulation resistance characteristics.

However, in a case in which a ferroelectric material is used as the dielectric material, as a particle size is decreased, permittivity is decreased, and the ferroelectric material has aging characteristics in which permittivity is decreased with the passage of time. In addition, a change in permittivity depending on a change in temperature is large, such that permittivity is rapidly decreased at temperatures of 125° C. or higher, and insulation resistance is low, such that it is difficult to use the ferroelectric material at temperatures of 150° C. or higher.

Further, since in most cases, a capacitor is used in an actual device circuit in an environment in which a direct current (DC) voltage is applied thereto, it is important to implement high capacitance in a DC electric field.

When the magnitude of the DC electric field applied per unit thickness is gradually increased in accordance with the development of the capacitor, so that the capacitor containing the ferroelectric material such as BaTiO₃ has been thinned and capacitance of the capacitor increased, a decrease ineffective capacitance at the same DC voltage may be gradually increased.

In order to solve this problem, a paraelectric material of which a permittivity is not changed depending on the DC electric field may be used.

Since a dielectric material having excellent DC-bias characteristics as described above may have advantages such as excellent durability in an electrostatic discharge (ESD) environment and low acoustic noise, the dielectric material may be usefully used in capacitor products requiring these characteristics.

However, in the case of a COG-based paraelectric material, currently widely used in the electronics industry, permittivity may be excessively low (about 30), such that it is difficult to manufacture a high capacitance multilayer ceramic capacitor (MLCC).

Therefore, in order to implement high capacitance in the MLCC while implementing the characteristics as described above, a ferroelectric material having high permittivity has been required.

### SUMMARY

An aspect of the present disclosure may provide a high-permittivity dielectric ceramic composition of which permittivity is not changed when a direct current (DC) electric field is applied thereto, and a multilayer ceramic capacitor containing the same.

According to an aspect of the present disclosure, a dielectric ceramic composition may contain a base material powder represented by (Ca₁₋ₓSrₓ)(Zr_{1-y}Ti_{y})O₃ (0≦x≦1.0 and 0.3≦y≦0.8).

According to another aspect of the present disclosure, a multilayer ceramic capacitor may include a ceramic body in which dielectric layers and first and second internal electrodes are alternately stacked, wherein the dielectric layer contains a dielectric ceramic composition containing a base material powder represented by (Ca₁₋ₓSrₓ)(Zr_{1-y}Ti_{y})O₃ (0≦x≦1.0 and 0.3≦y≦0.8).

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a graph illustrating changes in permittivity in relation to an alternating current (AC) electric field in the Inventive Example and the Comparative Example of the present disclosure;

FIG. 2 is a graph illustrating changes in capacitance in relation to a direct current (DC) electric field in the Inventive Example and the Comparative Example of the present disclosure;

FIG. 3 is a graph illustrating changes in permittivity in relation to temperature in the Inventive Example and the Comparative Example of the present disclosure;

FIG. 4 is a perspective view schematically illustrating a multilayer ceramic capacitor according to an exemplary embodiment in the present disclosure; and

FIG. 5 is a schematic cross-sectional view illustrating the multilayer ceramic capacitor taken along line V-V′ of FIG. 4.

### DETAILED DESCRIPTION

Hereinafter, embodiments of the present inventive concept will be described as follows with reference to the attached drawings.

The present inventive concept may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present inventive concept will be described with reference to schematic views illustrating embodiments of the present inventive concept. In the drawings, for example, due to manufacturing techniques and/or tolerances, modifications of the shape shown may be estimated. Thus, embodiments of the present inventive concept should not be construed as being limited to the particular shapes of regions shown herein, for example, to include a change in shape results in manufacturing. The following embodiments may also be constituted by one or a combination thereof.

The contents of the present inventive concept described below may have a variety of configurations and propose only a required configuration herein, but are not limited thereto.

The present disclosure relates to a dielectric ceramic composition. Examples of electronic components containing the dielectric ceramic composition include capacitors, inductors, piezoelectric elements, varistors, thermistors, and the like. Hereinafter, the dielectric ceramic composition and a multilayer ceramic capacitor as an example of the electronic component will be described.

The dielectric ceramic composition according to an exemplary embodiment in the present disclosure may contain a base material powder represented by (Ca₁₋ₓSrₓ)(Zr_{1-y}Ti_{y})O₃ (0≦x≦1.0 and 0.3≦y≦0.8).

According to the exemplary embodiment in the present disclosure, high permittivity of 90 or more, about 3 times permittivity of a COG-based paraelectric material, may be obtained by adjusting a ratio of Zr/Ti or a y value in the base material powder.

Further, temperature coefficient of capacitance (TCC) characteristics of the dielectric ceramic composition according to the exemplary embodiment in a temperature range of X8R or higher (−55° C.˜175° C.) may be excellent and a change in permittivity depending on AC and DC electric fields may be significantly low.

In addition, reduction resistance characteristics enabling the use of Ni internal electrodes, high insulation resistance, and excellent reliability may be implemented by adding a sintering additive including SiO₂ and MnO₂, and Y₂O₃ to the base material powder as described below.

Hereinafter, each ingredient of the dielectric ceramic composition according to the exemplary embodiment in the present disclosure will be described in detail.

a) Base Material Powder

The dielectric ceramic composition according to the exemplary embodiment in the present disclosure may contain a base material powder represented by (Ca₁₋ₓSrₓ)(Zr_{1-y}Ti_{y})O₃ (0≦x≦1.0 and 0.3≦y≦0.8).

Here, x may satisfy 0≦x≦1.0, and y may satisfy 0.3≦y≦0.8.

Generally, in a dielectric ceramic composition applied to a multilayer ceramic capacitor having electrostatic discharge (ESD) protection characteristics, a dielectric material satisfying X7R characteristics as a ferroelectric material, or a COG-based paraelectric material has been used.

However, in the case of using the ferroelectric material, since high permittivity may be secured, a dielectric layer may be designed to be relatively thick, but at the time of evaluating electrostatic discharge (ESD) protection characteristics, electrostrictive cracks may occur under a high electric field environment, or actual capacitance may be decreased due to DC-bias characteristics, such that a higher voltage may be actually applied to the capacitor, thereby deteriorating the ESD characteristics.

Further, in a case of using the COG-based paraelectric material, since permittivity is low, in order to secure desired capacitance of the capacitor, a dielectric layer should be relatively thin, and thus, withstand voltage characteristics may be deteriorated, such that ESD protection characteristics may not be satisfied.

In addition, since permittivity of a COG-based paraelectric material currently widely used in the electronics industry is excessively low (about 30), it may be difficult to manufacture a high capacitance multilayer ceramic capacitor therewith.

According to the exemplary embodiment in the present disclosure, the dielectric ceramic composition may contain the base material powder in which a paraelectric material having excellent DC-bias characteristics is used, but of which room-temperature permittivity is improved by about 3 or more times as compared to a general paraelectric material.

Therefore, the dielectric ceramic composition according to the exemplary embodiment in the present disclosure may have excellent DC-bias characteristics, that is, at the time of applying the direct current (DC) electric field, there is no change in permittivity. Thus, capacitance is not decreased, such that high capacitance characteristics may be implemented.

In order to increase room-temperature permittivity of the paraelectric material, among solid solution elements of the material, a ratio of Zr/Ti may be adjusted.

That is, according to the exemplary embodiment in the present disclosure, permittivity may be increased by 3 or more times as compared to the general paraelectric material by adjusting y, indicating the ratio of Zr/Ti, to satisfy 0.3≦y≦0.8.

In detail, y, indicating the ratio of Zr/Ti, may be adjusted to satisfy 0.3≦y≦0.8, such that permittivity may be high as compared to the existing COG material, DC-bias characteristics may be excellent, insulation resistance and withstand voltage may be high, reliability may be excellent, and temperature characteristics of X8R or higher (−55° C.˜175° C.) may be implemented.

In a case in which y is less than 0.3, since permittivity may be low, permittivity of 90 or more, a desired permittivity, may not be obtained. Accordingly, if such a composition is used to form a dielectric layer having a thin thickness in order to obtain the desired capacitance, withstand voltage characteristics may be deteriorated.

On the other hand, when y is greater than 0.8, temperature characteristics of X8R or higher (−55° C.˜175° C.) may not be implemented.

According to the exemplary embodiment in the present disclosure, room-temperature insulation resistance may be excellent by adjusting y, indicating the ratio of Zr/Ti, to satisfy 0.2≦y≦0.9.

However, in a case in which x and y are the same as each other, since room-temperature insulation resistance may be decreased, according to the exemplary embodiment in the present disclosure, x and y may be different from each other.

That is, the base material powder of the dielectric ceramic composition according to the exemplary embodiment may have high room-temperature permittivity and excellent DC-bias characteristics by adjusting a composition ratio of each ingredient within a predetermined range in the paraelectric material having excellent DC-bias characteristics.

Since the base material powder has room-temperature permittivity higher than that of a paraelectric material according to the related art, a dielectric layer may be designed to have a thicker thickness, and since excellent DC-bias characteristics may be exhibited, the ESD protection characteristics may also be excellent.

The base material powder is not particularly limited, but may have an average particle size of 1000 nm or less.

b) First Accessory Ingredient

According to the exemplary embodiment in the present disclosure, the dielectric ceramic composition may further contain an oxide or carbonate containing at least one of Mn, V, Cr, Fe, Ni, Co, Cu, and Zn as a first accessory ingredient.

The oxide or carbonate containing at least one of Mn, V, Cr, Fe, Ni, Co, Cu, and Zn as the first accessory ingredient may be contained in an amount of 0.2 to 4.0 at % based on 100 at % of the base material powder.

The first accessory ingredient may serve to decrease a sintering temperature of a multilayer ceramic capacitor using the dielectric ceramic composition and improve the high-temperature withstand voltage characteristics.

The content of the first accessory ingredient and a content of a second accessory ingredient to be described below, which are based on 100 at % of base material powder, may be particularly defined as at % of metal ions contained in each of the accessory ingredients.

When the content of the first accessory ingredient is less than 0.2 at %, reduction resistance and reliability may be deteriorated.

When the content of the first accessory ingredient is greater than 4.0 at %, side effects such as an increase in sintering temperature, deterioration of high-temperature withstand voltage, and the like, may occur.

Particularly, the dielectric ceramic composition according to the exemplary embodiment in the present disclosure may further contain 0.2 to 4.0 at % of first accessory ingredient based on 100 at % of a base material powder, such that the dielectric ceramic composition may be sintered at a low temperature and obtain excellent high-temperature withstand voltage characteristics.

c) Second Accessory Ingredient

According to the exemplary embodiment in the present disclosure, the dielectric ceramic composition may further contain 4.0 at % or less of a second accessory ingredient, an oxide or carbonate containing at least one of Y, Dy, Ho, La, Ce, Nd, Sm, Gd, and Er based on 100 at % of the base material powder.

The second accessory ingredient may be contained in an amount of 4.0 at % or less based on 100 at % of a base material main ingredient.

The content of the second accessory ingredient may be based on a content of at least one of Y, Dy, Ho, La, Ce, Nd, Sm, Gd, and Er contained in the second accessory ingredient without distinguishing additional forms such as an oxide form or a carbonate form.

For example, a total content of at least one of Y, Dy, Ho, La, Ce, Nd, Sm, Gd, and Er contained in the second accessory ingredient may be 4.0 at % or less based on 100 at % of the base material main ingredient.

According to the exemplary embodiment in the present disclosure, the second accessory ingredient may serve to prevent reliability of the multilayer ceramic capacitor to which the dielectric ceramic composition is applied from being deteriorated, and in a case in which the second accessory ingredient is contained in an amount of 4.0 at % or less based on 100 at % of the base material main ingredient, a dielectric ceramic composition capable of implementing high permittivity and having excellent high-temperature withstand voltage characteristics may be provided.

When the content of the second accessory ingredient is more than 4.0 at % based on 100 at % of the base material main ingredient, reliability may be deteriorated, or permittivity and high-temperature withstand voltage characteristics of the dielectric ceramic composition may be deteriorated.

d) Third Accessory Ingredient

According to the exemplary embodiment in the present disclosure, the dielectric ceramic composition may further contain 0.5 to 4.0 at % of a third accessory ingredient, an oxide or carbonate containing Si or a glass compound containing Si based on 100 at % of the base material powder.

The third accessory ingredient, the oxide or carbonate containing Si or the glass compound containing Si, may be added to the dielectric ceramic composition, such that the sintering temperature may be decreased, and the sintering may be promoted.

In a case in which the content of the third accessory ingredient is less than 0.5 at %, a degree of densification of the dielectric layer may be decreased, such that withstand voltage characteristics may be deteriorated.

In a case in which the content of the third accessory ingredient is more than 4.0 at %, withstand voltage characteristics may be deteriorated due to formation of secondary phase.

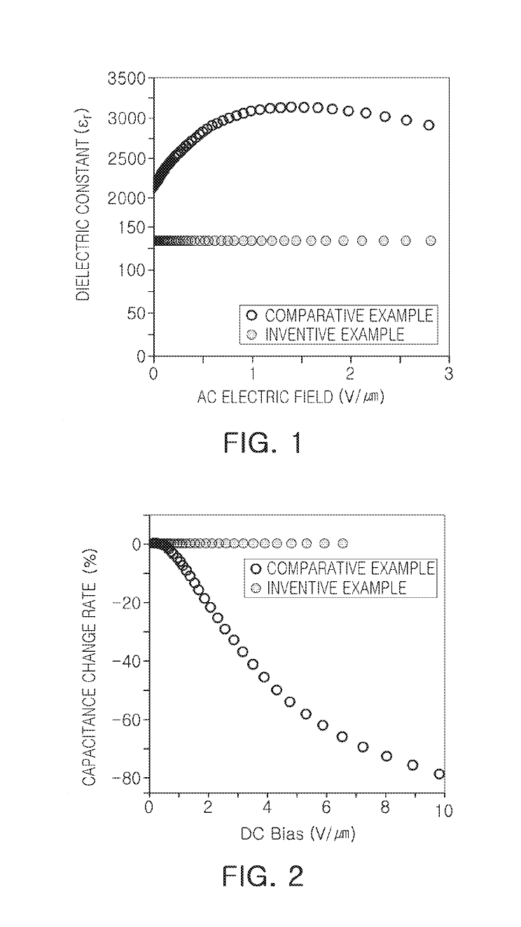

FIG. 1 is a graph illustrating changes in permittivity (dielectric constant) in relation to an alternating current (AC) electric field in the Inventive Example and the Comparative Example of the present disclosure.

FIG. 1 illustrates the changes in permittivity depending on a magnitude of the alternating current (AC) electric field in a multilayer ceramic capacitor sample (Comparative Example) having X7R characteristics (−55° C.˜125° C.) and using a ferroelectric BaTiO₃ material and a multilayer ceramic capacitor sample (Inventive Example of the present disclosure) using a paraelectric material, (Ca₁₋ₓSrₓ)(Zr_{1-y}Ti_{y})O₃, having permittivity of 130.

Referring to FIG. 1, it may be confirmed that in the Inventive Example in which the paraelectric material, (Ca₁₋ₓSrₓ)(Zr_{1-y}Ti_{y})O₃, was used, there was almost no change in permittivity depending on the magnitude of the AC electric field as compared to Comparative Example in which the BaTiO₃ material was used.

FIG. 2 is a graph illustrating changes in capacitance in relation to a direct current (DC) electric field in the Inventive Examples and the Comparative Examples of the present disclosure.

FIG. 2 illustrates the changes in capacitance depending on a magnitude of the DC electric field in a multilayer ceramic capacitor sample (Comparative Example) having the X7R characteristics (−55° C.˜125° C.) and using a ferroelectric BaTiO₃ material and a multilayer ceramic capacitor sample using a high permittivity paraelectric material according to the present disclosure, (Ca₁₋ₓSrₓ)(Zr_{1-y}Ti_{y})O₃.

Referring to FIG. 2, it may be confirmed that in the Inventive Example in which the paraelectric material, (Ca₁₋ₓSrₓ)(Zr_{1-y}Ti_{y})O₃, was used, there was almost no change in permittivity depending on the magnitude of the DC electric field as compared to Comparative Example in which the BaTiO₃ material was used, since there was no change in capacitance.

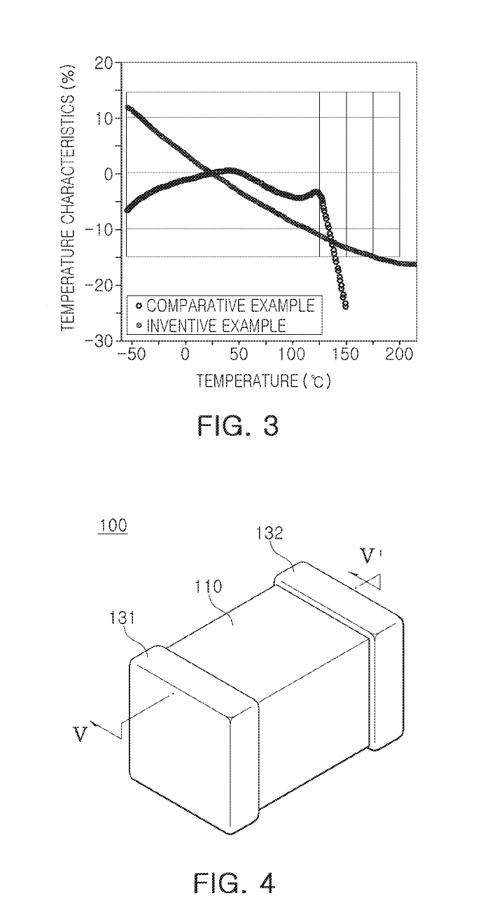

FIG. 3 is a graph illustrating changes in permittivity in relation to a temperature in the Inventive Examples and Comparative Examples of the present disclosure.

FIG. 3 illustrates the changes in permittivity (i.e., temperature characteristic) depending on the temperature in a multilayer ceramic capacitor sample (Comparative Example) having the X7R characteristics (−55° C.˜125° C.) and using a ferroelectric BaTiO₃ material and a multilayer ceramic capacitor sample using the high permittivity paraelectric material according to the present disclosure, (Ca₁₋ₓSrₓ)(Zr_{1-y}Ti_{y})O₃.

Referring to FIG. 3, it may be appreciated that in the Inventive Example in which the paraelectric material, (Ca₁₋ₓSrₓ)(Zr_{1-y}Ti_{y})O₃, was used, the temperature coefficient of capacitance (TCC) at 150° C. or higher was excellent as compared to Comparative Example in which the BaTiO₃ material was used, such that the temperature characteristics of X8R or higher (−55° C.˜175° C.) may be implemented.

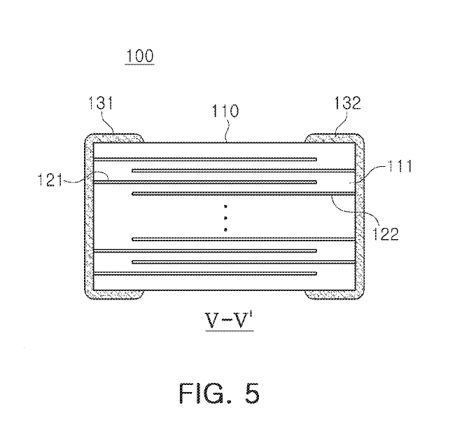

FIG. 4 is a perspective view schematically illustrating a multilayer ceramic capacitor 100 according to an exemplary embodiment in the present disclosure, and FIG. 5 is a schematic cross-sectional view illustrating the multilayer ceramic capacitor 100 taken along the line V-V′ of FIG. 4.

Referring to FIGS. 4 and 5, the multilayer ceramic capacitor 100 according to the exemplary embodiment in the present disclosure may include a ceramic body 110 in which dielectric layers 111 and first and second internal electrodes 121 and 122 are alternately stacked. First and second external electrodes 131 and 132 electrically connected to the first and second internal electrodes 121 and 122 alternately disposed in the ceramic body 110, respectively, may be formed on both end portions of the ceramic body 110.

A shape of the ceramic body 110 is not particularly limited, but generally, may be a rectangular parallelepiped.

In addition, dimensions of the ceramic body 110 are not particularly limited, and the ceramic body may have suitable dimensions, depending on the use thereof. For example, the ceramic body may have dimensions of (0.6˜5.6 mm)×(0.3˜5.0 mm)×(0.3˜1.9 mm).

A thickness of the dielectric layer 111 may be optionally changed according to capacitance design of the capacitor. According to the exemplary embodiment in the present disclosure, a thickness of a single dielectric layer may be preferably 0.1 μm or more after sintering.

In a case in which the dielectric layer is excessively thin, the number of grains existing in the single dielectric layer is low, which has a negative influence on reliability. Therefore, the thickness of the dielectric layer may be 0.1 μm or more.

The first and second internal electrodes 121 and 122 may be stacked so that end surfaces thereof are alternately exposed to surfaces of both end portions of the ceramic body 110 opposing each other, respectively.

The first and second external electrodes 131 and 132 may be formed on both end portions of the ceramic body 110 and electrically connected to the exposed end surfaces of the first and second internal electrodes 121 and 122 that are alternately disposed, thereby configuring a capacitor circuit.

Although a conductive material contained in the first and second internal electrodes 121 and 122 is not particularly limited, since a material configuring the dielectric layer according to the exemplary embodiment of the present disclosure may contain the paraelectric material, a noble metal may be generally used, but nickel (Ni) internal electrodes may be used in the exemplary embodiment in the present disclosure.

The noble metal used as the conductive material may be a silver (Ag) or palladium (Pd) alloy.

A thickness of the first and second internal electrodes 121 and 122 may be appropriately determined depending on the use, or the like, but is not particularly limited. For example, the thickness may be 0.1 to 5 μm or 0.1 to 2.5 μm.

The conductive material contained in the first and second external electrodes 131 and 132 is not particularly limited, but nickel (Ni), copper (Cu), or an alloy thereof may be used.

A thickness of the first and second external electrodes 131 and 132 may be appropriately determined depending on the use, or the like, but is not particularly limited. For example, the thickness may be 10 to 50 μm.

The dielectric layer 111 configuring the ceramic body 110 may contain the dielectric ceramic composition according to the exemplary embodiment in the present disclosure.

The dielectric ceramic composition according to the exemplary embodiment in the present disclosure may contain a base material powder represented by (Ca₁₋ₓSrₓ)(Zr_{1-y}Ti_{y})O₃ (0≦x≦1.0 and 0.3≦y≦0.8).

Since features of the dielectric ceramic composition are the same as those of the dielectric ceramic composition according to the exemplary embodiment in the present disclosure described above, a detailed description thereof will be omitted.

Hereinafter, the present disclosure will be described in detail through the Inventive Examples and Comparative Examples, but these are only to help in gaining a specific understanding of the present disclosure. Therefore, the scope of the present disclosure is not limited to the Inventive Examples.

A main ingredient (Ca₁₋ₓSrₓ)(Zr_{1-y}Ti_{y})O₃ powder, a base material powder, was prepared using a solid phase method as follows.

Starting materials were CaCO₃, SrCO₃, ZrO₂, and TiO₂.

First, these powders were weighed according to the designed ratio, mixed with each other, and calcined at 800 to 900° C. using a ball mill, thereby preparing (Ca₁₋ₓSrₓ)(Zr_{1-y}Ti_{y})O₃ powder having an average particle size of 300 nm.

After the (Ca₁₋ₓSrₓ)(Zr_{1-y}Ti_{y})O₃ powder (base material main ingredient) and each of the accessory ingredients, MnO₂, Y₂O₃, and SiO₂, were weighed according to the composition ratios of respective Experimental Examples illustrated in the following Tables 1 and 2, a raw material powder containing the main ingredient and the accessory ingredients was mixed with ethanol/toluene, a dispersant, and a binder using zirconia balls as mixing/dispersing media, and then ball-milled for 20 hours.

Forming sheets having a thickness of 5.0 μm and a thickness of 10 to 13 μm were manufactured using the prepared slurry and a coater in a doctor blade scheme.

A Ni internal electrode was printed on the forming sheets to form active sheets.

Upper and lower covers were manufactured by stacking 25 cover sheets (thickness: 10 to 13 μm), and 21 active sheets on which the Ni internal electrode was printed were stacked while being compressed, thereby manufacturing a bar.

A compressed bar was cut into chips having a 3216 size (length×width×thickness: 3.2 mm×1.6 mm×1.6 mm) using a cutter.

After the cut chip was calcined and sintered at 1230 to 1270° C. for 2 hours under a reduction atmosphere (1% H₂/99% N₂, H₂O/H₂/N₂), the sintered chip was heat-treated by performing re-oxidation at 1000° C. for 3 hours under a nitrogen (N₂) atmosphere.

External electrodes were completed by terminating the sintered chip using a copper (Cu) paste and sintering the formed electrodes.

Capacitance, dissipation factors (DF), insulation resistance, temperature coefficients of capacitance (TCC), resistance degradation behaviors depending on a voltage step increase at a high temperature of 150° C., and the like, of prototype multilayer ceramic capacitor (MLCC) samples completed as described above were evaluated.

The room-temperature capacitance and dissipation factor of the multilayer ceramic capacitor (MLCC) were measured at 1 kHz and AC voltage of 0.5 V/μm using a LCR-meter.

Permittivity of the multilayer ceramic capacitor (MLCC) was calculated from the capacitance, a thickness of a dielectric layer, an area of the internal electrodes, and the number of stacked dielectric layers of the multilayer ceramic capacitor (MLCC).

Room temperature insulation resistance (IR) was measured after 60 seconds in a state in which ten samples each were taken and a DC voltage of 10 V/μm was applied thereto.

The temperature coefficient of capacitance (TCC) was measured in a temperature range from −55 to 175° C.

In a high-temperature IR boosting test, the resistance degradation behavior was measured while increasing the voltage step by 10 V/μm at 170° C. and a resistance value was measured every 5 seconds, wherein the time of each step was 10 minutes.

The high-temperature withstand voltage was derived from the high-temperature IR boosting test, wherein the high-temperature withstand voltage is a voltage at which an IR may withstand 10⁵Ω or more when the measurement was conducted while continuously increasing the voltage step after applying the voltage step of DC 5 V/μm to a 3216 size chip having 20 dielectric layers having a thickness of 3.2 μm after sintering at 175° C. for 10 minutes.

TABLE 1

| | | | | | Content (mole) of Each Additive Based on 100 moles of | | | | |
|---|---|---|---|---|---|---|---|---|---|
| | A-Site | | B-Site | | Base material ((Ca₁₋ₓSrₓ)(Zr_{1-y}Ti_{y})O₃) | | | | |
| | (Ca₁₋ₓSrₓ) | | (Zr_{1-y}Ti_{y}) | | 1st | | 2nd | | 3rd |
| | Content | Content | Content | Content | Accessory | | Accessory | | Accessory |
| Inventive | of Ca | of Sr | of Zr | of Ti | Ingredient | | Ingredient | | Ingredient |
| Example | 1 − x | x | 1 − y | y | MnO₂ | V₂O₅ | Y₂O₃ | Dy₂O₃ | SiO₂ |
| 1 | 1.000 | 0.000 | 1.000 | 0.000 | 0.50 | 0.00 | 0.00 | 0.00 | 0.50 |
| 2 | 1.000 | 0.000 | 0.900 | 0.100 | 0.50 | 0.00 | 0.00 | 0.00 | 0.50 |
| 3 | 1.000 | 0.000 | 0.800 | 0.200 | 0.50 | 0.00 | 0.00 | 0.00 | 0.50 |
| 4 | 1.000 | 0.000 | 0.700 | 0.300 | 0.50 | 0.00 | 0.00 | 0.00 | 0.50 |
| 5 | 1.000 | 0.000 | 0.600 | 0.400 | 0.50 | 0.00 | 0.00 | 0.00 | 0.50 |
| 6 | 1.000 | 0.000 | 0.500 | 0.500 | 0.50 | 0.00 | 0.00 | 0.00 | 0.50 |
| 7 | 1.000 | 0.000 | 0.400 | 0.600 | 0.50 | 0.00 | 0.00 | 0.00 | 0.50 |
| 8 | 1.000 | 0.000 | 0.300 | 0.700 | 0.50 | 0.00 | 0.00 | 0.00 | 0.50 |
| 9 | 1.000 | 0.000 | 0.200 | 0.800 | 0.50 | 0.00 | 0.00 | 0.00 | 0.50 |
| 10 | 1.000 | 0.000 | 0.100 | 0.900 | 0.50 | 0.00 | 0.00 | 0.00 | 0.50 |
| 11 | 0.800 | 0.200 | 0.400 | 0.600 | 0.50 | 0.00 | 0.00 | 0.00 | 0.50 |
| 12 | 0.600 | 0.400 | 0.400 | 0.600 | 0.50 | 0.00 | 0.00 | 0.00 | 0.50 |
| 13 | 0.400 | 0.600 | 0.400 | 0.600 | 0.50 | 0.00 | 0.00 | 0.00 | 0.50 |
| 14 | 0.200 | 0.800 | 0.400 | 0.600 | 0.50 | 0.00 | 0.00 | 0.00 | 0.50 |
| 15 | 0.000 | 1.000 | 0.400 | 0.600 | 0.50 | 0.00 | 0.00 | 0.00 | 0.50 |

TABLE 2

| | SPL Characteristics of Ni-MLCC Proto-Type | | | | | | | | |
|---|---|---|---|---|---|---|---|---|---|
| | (Permittivity/DF Measurement Condition: AC 0.5 V/μm, 1 kHz, Room-Temperature Specific Resistance: DC 10 V/μm) | | | | | | | | |
| | Room- | | | | | | | High-Temperature | |
| Experimental | Temperature | | | TCC(%) | TCC(%) | TCC(%) | TCC(%) | Withstand Voltage | Judgment of |
| Example | Permittivity | DF(%) | RC(Ω F.) | (−55° C.) | (125° C.) | (150° C.) | (175° C.) | (175° C.) (V/μm)° | Characteristics |
| 1 | 30 | <0.1% | 2354 | 0.0% | 0.0% | 0.0% | 0.0% | 75 | X |
| 2 | 41 | <0.1% | 2458 | 1.1% | −1.9% | −2.2% | −2.3% | 75 | X |
| 3 | 63 | <0.1% | 3011 | 2.5% | −2.4% | −2.7% | −2.9% | 70 | X |
| 4 | 90 | <0.1% | 3364 | 4.5% | −4.4% | −5.6% | −6.2% | 70 | ◯ |
| 5 | 100 | <0.1% | 4052 | 7.3% | −6.8% | −7.7% | −8.0% | 70 | ◯ |
| 6 | 112 | <0.1% | 3842 | 10.5% | −9.5% | −10.8% | −11.4% | 70 | ◯ |
| 7 | 129 | <0.1% | 3711 | 12.4% | −11.1% | −11.9% | −12.4% | 70 | ◯ |
| 8 | 145 | <0.1% | 1964 | 13.9% | −12.9% | −13.3% | −13.9% | 65 | ◯ |
| 9 | 161 | <0.1% | 1123 | 14.8% | −18.9% | −14.4% | −14.9% | 55 | ◯ |
| 10 | 180 | <0.1% | 371 | 20.0% | −16.4% | −16.8% | −16.2% | 50 | X |
| 11 | 131 | <0.1% | 3647 | 12.4% | −11.3% | −12.7% | −13.3% | 70 | ◯ |
| 12 | 129 | <0.1% | 3955 | 12.4% | −11.2% | −12.5% | −13.2% | 70 | ◯ |
| 13 | 128 | <0.1% | 3845 | 12.2% | −11.6% | −12.7% | −18.1% | 70 | ◯ |
| 14 | 130 | <0.1% | 3756 | 12.5% | −11.4% | −12.4% | −13.0% | 70 | ◯ |
| 15 | 135 | <0.1% | 3264 | 12.6% | −11.3% | −12.5% | −12.9% | 70 | ◯ |

Referring to Table 1, Inventive Examples 1 to 10 indicate cases in which when contents of the first accessory ingredient MnO₂ and the third accessory ingredient SiO₂ were 0.5 at % and 0.5 at %, respectively, based on 100 at % of the main ingredient (Ca₁₋ₓSrₓ)(Zr_{1-y}Ti_{y})O₃ powder, and a content x of Sr of the first main ingredient was 0, a content y of Ti was changed, and Experimental Examples 1 to 10 of Table 2 indicate characteristics of prototype multilayer ceramic capacitors according to Inventive Examples 1 to 10.

Referring to FIGS. 1 and 2, it may be appreciated that as the content y of the Ti was increased, room-temperature permittivity was increased, and at the same time, TCC (175° C.) corresponding to TCC at a high temperature of 175° C. was decreased, and withstand voltage characteristics at a high temperature of 175° C. were deteriorated.

When the content y of Ti was 0.3 or more, permittivity of 90 or more may be obtained, but when the content y was excessively high (0.9 or more), TCC (175° C.) was outside of the range of ±15%.

When the content y of Ti satisfied 0.3≦y≦0.8, all the desired characteristics of the present disclosure, that is, permittivity of 90 or more, a RC value of 1000 or more, temperature characteristics of X9R, and high-temperature withstand voltage (175° C.) of 50V/μm or more may be simultaneously implemented. Therefore, it may be appreciated that a suitable content y satisfied 0.3≦y≦0.8.

Inventive Examples 11 to 15 of Table 1 indicate cases in which when the contents of the first accessory ingredient MnO₂, and the third accessory ingredient SiO₂, were 0.5 at % and 0.5 at %, respectively, based on 100 at % of the main ingredient (Ca₁₋ₓSrₓ)(Zr_{1-y}Ti_{y})O₃ powder, and a content y of Ti of the first main ingredient was 0.6, a content x of Sr was changed, and Experimental Examples 11 to 15 of Table 2 indicate characteristics of prototype multilayer ceramic capacitors according to Inventive Examples 11 to 15.

It may be appreciated that in the entire content range of Sr (0≦x≦1.0), permittivity, DF, room-temperature RC values, TCC (175° C.), and high-temperature withstand voltage characteristics (175° C.) were implemented at similar levels to each other, and the desired characteristics of the present disclosure were satisfied.

Therefore, it may be appreciated that a suitable content x of Sr satisfied 0≦X≦1.0.

TABLE 3

| | | | | | Content (mole) of Each Additive Based on 100 moles of | | | | |
|---|---|---|---|---|---|---|---|---|---|
| | A-Site | | B-Site | | Base material ((Ca₁₋ₓSrₓ)(Zr_{1-y}Ti_{y})O₃) | | | | |
| | (Ca₁₋ₓSrₓ) | | (Zr_{1-y}Ti_{y}) | | 1st | | 2nd | | 3rd |
| | Content | Content | Content | Content | Accessory | | Accessory | | Accessory |
| Inventive | of Ca | of Sr | of Zr | of Ti | Ingredient | | Ingredient | | Ingredient |
| Example | 1 − x | x | 1 − y | y | MnO₂ | V₂O₅ | Y₂O₃ | Dy₂O₃ | SiO₂ |
| 16 | 0.600 | 0.400 | 0.400 | 0.600 | 0.10 | 0.00 | 0.00 | 0.00 | 0.50 |
| 17 | 0.600 | 0.400 | 0.400 | 0.600 | 0.20 | 0.00 | 0.00 | 0.00 | 0.50 |
| 18 | 0.600 | 0.400 | 0.400 | 0.600 | 1.00 | 0.00 | 0.00 | 0.00 | 0.50 |
| 19 | 0.600 | 0.400 | 0.400 | 0.600 | 2.00 | 0.00 | 0.00 | 0.00 | 0.50 |
| 20 | 0.600 | 0.400 | 0.400 | 0.600 | 3.00 | 0.00 | 0.00 | 0.00 | 0.50 |
| 21 | 0.600 | 0.400 | 0.400 | 0.600 | 4.00 | 0.00 | 0.00 | 0.00 | 0.50 |
| 22 | 0.600 | 0.400 | 0.400 | 0.600 | 5.00 | 0.00 | 0.00 | 0.00 | 0.50 |
| 23 | 0.600 | 0.400 | 0.400 | 0.600 | 1.50 | 0.25 | 0.00 | 0.00 | 0.50 |
| 24 | 0.600 | 0.400 | 0.400 | 0.600 | 1.00 | 0.50 | 0.00 | 0.00 | 0.50 |
| 25 | 0.600 | 0.400 | 0.400 | 0.600 | 0.50 | 0.75 | 0.00 | 0.00 | 0.50 |
| 26 | 0.600 | 0.400 | 0.400 | 0.600 | 0.00 | 1.00 | 0.00 | 0.00 | 0.50 |
| 27 | 0.600 | 0.400 | 0.400 | 0.600 | 2.00 | 0.00 | 0.50 | 0.00 | 0.50 |
| 28 | 0.600 | 0.400 | 0.400 | 0.600 | 2.00 | 0.00 | 1.00 | 0.00 | 0.50 |
| 29 | 0.600 | 0.400 | 0.400 | 0.600 | 2.00 | 0.00 | 2.00 | 0.00 | 0.50 |
| 30 | 0.600 | 0.400 | 0.400 | 0.600 | 2.00 | 0.00 | 3.00 | 0.00 | 0.50 |
| 31 | 0.600 | 0.400 | 0.400 | 0.600 | 2.00 | 0.00 | 0.00 | 1.00 | 0.50 |
| 32 | 0.600 | 0.400 | 0.400 | 0.600 | 2.00 | 0.00 | 0.00 | 2.00 | 0.50 |
| 33 | 0.600 | 0.400 | 0.400 | 0.600 | 2.00 | 0.00 | 0.00 | 3.00 | 0.50 |
| 34 | 0.600 | 0.400 | 0.400 | 0.600 | 2.00 | 0.00 | 1.00 | 1.00 | 0.50 |
| 35 | 0.600 | 0.400 | 0.400 | 0.600 | 2.00 | 0.00 | 1.00 | 0.00 | 0.25 |
| 36 | 0.600 | 0.400 | 0.400 | 0.600 | 2.00 | 0.00 | 1.00 | 0.00 | 1.00 |
| 37 | 0.600 | 0.400 | 0.400 | 0.600 | 2.00 | 0.00 | 1.00 | 0.00 | 2.00 |
| 38 | 0.600 | 0.400 | 0.400 | 0.600 | 2.00 | 0.00 | 1.00 | 0.00 | 3.00 |
| 38 | 0.600 | 0.400 | 0.400 | 0.600 | 2.00 | 0.00 | 1.00 | 0.00 | 4.00 |
| 39 | 0.600 | 0.400 | 0.400 | 0.600 | 2.00 | 0.00 | 1.00 | 0.00 | 5.00 |

TABLE 4

| | SPL Characteristics of Ni-MLCC Proto-Type | | | | | | | | |
|---|---|---|---|---|---|---|---|---|---|
| | (Permittivity/DF Measurement Condition: AC 0.5 V/μm, 1 kHz. Room-Temperature Specific Resistance: DC 10 V/μm) | | | | | | | | |
| | Room- | | | | | | | High-Temperature | |
| Experimental | Temperature | | | TCC(%) | TCC(%) | TCC(%) | TCC(%) | Withstand Voltage | Judgment of |
| Example | Permittivity | DF(%) | RC(Ω F.) | (−55° C.) | (125° C.) | (150° C.) | (175° C.) | (175° C.) (V/μm)° | Characteristics |
| 16 | 133 | <0.1% | 2245 | 12.5% | −11.1% | −12.3% | −12.7% | 35 | X |
| 17 | 132 | <0.1% | 2658 | 12.6% | −11.2% | −12.5% | −13.0% | 55 | ◯ |
| 18 | 131 | <0.1% | 3325 | 12.2% | −11.0% | −12.1% | −12.8% | 70 | ◯ |
| 19 | 132 | <0.1% | 4012 | 12.0% | −10.6% | −11.9% | −12.5% | 80 | ◯ |
| 20 | 132 | <0.1% | 4012 | 12.0% | −10.6% | −11.9% | −12.5% | 80 | ◯ |
| 21 | 130 | <0.1% | 3265 | 11.9% | −10.5% | −11.7% | −12.1% | 75 | ◯ |
| 22 | 124 | <0.1% | 1568 | 11.5% | −10.2% | −11.4% | −11.8% | 45 | X |
| 23 | 133 | <0.1% | 4003 | 12.4% | −10.7% | −12.0% | −12.7% | 80 | ◯ |
| 24 | 135 | <0.1% | 3978 | 12.5% | −10.8% | −12.1% | −12.6% | 80 | ◯ |
| 25 | 134 | <0.1% | 3856 | 12.5% | −11.1% | −11.9% | −12.8% | 80 | ◯ |
| 26 | 133 | <0.1% | 3652 | 12.6% | −11.0% | −11.9% | −12.7% | 75 | ◯ |
| 27 | 131 | <0.1% | 4226 | 12.5% | −10.8% | −12.0% | −13.0% | 95 | ◯ |
| 28 | 130 | <0.1% | 4356 | 12.4% | −10.7% | −11.9% | −12.8% | 100 | ◯ |
| 29 | 132 | <0.1% | 4471 | 12.2% | −10.6% | −11.5% | −12.6% | 80 | ◯ |
| 30 | 129 | <0.1% | 4853 | 12.1% | −10.5% | −11.4% | −12.4% | 40 | X |
| 31 | 130 | <0.1% | 4258 | 12.3% | −11.0% | −12.2% | −13.0% | 105 | ◯ |
| 32 | 131 | <0.1% | 4126 | 12.5% | −11.0% | −11.3% | −12.4% | 80 | ◯ |
| 33 | 130 | <0.1% | 4629 | 12.5% | −10.5% | −11.7% | −12.3% | 45 | X |
| 34 | 131 | <0.1% | 4358 | 12.3% | −10.7% | −11.7% | −12.8% | 85 | ◯ |
| 35 | 118 | <0.1% | 2569 | 11.8% | −10.5% | −11.7% | −12.5% | 45 | X |
| 36 | 132 | <0.1% | 4428 | 12.3% | −10.7% | −11.9% | −12.7% | 100 | ◯ |
| 37 | 133 | <0.1% | 4571 | 12.2% | −10.7% | −11.7% | −12.8% | 105 | ◯ |
| 38 | 135 | <0.1% | 4396 | 12.4% | −10.7% | −11.8% | −12.5% | 85 | ◯ |
| 38 | 124 | <0.1% | 3024 | 12.5% | −10.7% | −11.6% | −12.6% | 60 | ◯ |
| 39 | 121 | <0.1% | 2047 | 12.6% | −10.7% | −11.5% | −12.7% | 40 | X |

Inventive Examples 16 to 22 of Table 3 indicate cases in which when x was 0.4 and y was 0.6 in the main ingredient (Ca₁₋ₓSrₓ)(Zr_{1-y}Ti_{y})O₃ powder and a content of the third accessory ingredient SiO₂ was 0.5 wt %, a content of the first accessory ingredient Mn was changed, and Experimental Examples 16 to 22 of Table 4 indicate characteristics of prototype multilayer ceramic capacitors according to Inventive Examples 16 to 22.

In Experimental Example 16 in which the content of Mn was low (0.1 at %), high-temperature withstand voltage (175° C.) was decreased to 35V/μm, in Experimental Examples 17 to 21 in which the content of Mn was increased to 0.2 at % or more, high-temperature withstand voltage (175° C.) was increased to 50V/μm or more, and in Experimental Example 22 in which the content of Mn was excessively high (5 at %), a secondary phase was formed, such that high-temperature withstand voltage (175° C.) was decreased below 50V/μm again.

Therefore, it may be appreciated that a suitable content of the first accessory ingredient (Mn) was 0.2 to 4 at %.

Inventive Examples 27 to 30 of Table 3 indicate cases in which when x was 0.4 and y was 0.6 in the main ingredient (Ca₁₋ₓSrₓ)(Zr_{1-y}Ti_{y})O₃ powder, a content of the first accessory ingredient Mn was 2.0 at %, and a content of the third accessory ingredient SiO₂ was 0.5 at %, a content of the second accessory ingredient Y₂O₃ was changed, and Experimental Examples 27 to 30 of Table 4 indicate characteristics of prototype multilayer ceramic capacitors according to Inventive Examples 27 to 30.

As the content of Y was increased, high-temperature withstand voltage (175° C.) was increased but decreased again, and in Experimental Example 30 in which the content was excessively high (6 at %) based on at %, high-temperature withstand voltage (175° C.) was decreased below 50V/μm again due to formation of a secondary phase, or the like.

Therefore, it may be appreciated that a suitable content of the second accessory ingredient Y was 4 at % or less based on 100 at % of the main ingredient (Ca₁₋ₓSrₓ)(Zr_{1-y}Ti_{y})O₃ powder.

Inventive Examples 31 to 34 of Table 3 indicate cases in which when x was 0.4 and y was 0.6 in the main ingredient (Ca₁₋ₓSrₓ)(Zr_{1-y}Ti_{y})O₃ powder, a content of the first accessory ingredient Mn was 2.0 at %, and a content of the third accessory ingredient SiO₂ was 0.5 at %, Dy₂O₃ as the second accessory ingredient was used instead of Y₂O₃, or Y₂O₃ and Dy₂O₃ were added together with each other, and Experimental Examples 31 to 34 of Table 4 indicate characteristics of prototype multilayer ceramic capacitors according to Inventive Examples 31 to 34.

It may be confirmed that when the entire content of the second accessory ingredient was equal based on at %, in a case in which Y or Dy was added alone or a case in which Y and Dy were added together each other, characteristics of the prototype multilayer ceramic capacitors were almost equal to each other. Further, it may be appreciated that in Experimental Example 33 in which the content of a secondary accessory ingredient Dy was excessively high (6 at %), similarly, high-temperature withstand voltage (175° C.) was decreased below 50V/μm.

Inventive Examples 35 to 39 of Table 3 indicate cases in which when x was 0.4 and y was 0.6 in the main ingredient (Ca₁₋ₓSrₓ)(Zr_{1-y}Ti_{y})O₃ powder, a content of the first accessory ingredient Mn was 2.0 at %, and a content of the second accessory ingredient Y₂O₃ was 1.0 at %, a content of the third accessory ingredient SiO₂ was changed, and Experimental Examples 35 to 39 of Table 4 indicate characteristics of prototype multilayer ceramic capacitors according to Inventive Examples 35 to 39.

In Experimental Example 35 in which the content of SiO₂ was excessively low (0.25 at %), a degree of densification of the dielectric layers was decreased, and thus high-temperature withstand voltage (175° C.) was decreased below 50V/μm. It may be confirmed that as the content of SiO₂ was increased, high-temperature withstand voltage (175° C.) was increased but decreased again, and in a case in which the content of SiO₂ was excessively high (5 at %), high-temperature withstand voltage (175° C.) was also decreased below 50V/μm due to formation of a secondary phase, or the like.

Since all the desired characteristics of the present disclosure may be simultaneously implemented when the content of SiO₂ was in a range of 0.5 to 4.0 at %, it may be appreciated that a suitable content of the third accessory ingredient SiO₂ was 0.5 to 4.0 at %.

As set forth above, according to the exemplary embodiments, the multilayer ceramic capacitor using the dielectric ceramic composition according to the exemplary embodiment in the present disclosure may have excellent DC-bias characteristics, that is, at the time of applying the direct current (DC) electric field, there is no change in permittivity, and thus capacitance is not decreased, such that high capacitance characteristics may be implemented.

While exemplary embodiments have been shown and described above, it will be apparent to those skilled in the art that modifications and variations could be made without departing from the scope of the present invention as defined by the appended claims.

What is claimed is:

1. A dielectric ceramic composition comprising a base material powder represented by (Ca₁₋ₓSrₓ)(Zr_{1-y}Ti_{y})O₃ (0≦x≦1.0 and 0.3≦y≦0.8).

2. The dielectric ceramic composition of claim 1, further comprising 0.2 to 4.0 at % of a first accessory ingredient including at least one of Mn, V, Cr, Fe, Ni, Co, Cu, and Zn, based on 100 at % of the base material powder.

3. The dielectric ceramic composition of claim 2, wherein the first accessory ingredient includes oxide or carbonate.

4. The dielectric ceramic composition of claim 1, further comprising 4.0 at % or less of a second accessory ingredient including at least one of Y, Dy, Ho, La, Ce, Nd, Sm, Gd, and Er, based on 100 at % of the base material powder.

5. The dielectric ceramic composition of claim 4, wherein the second accessory ingredient includes oxide or carbonate.

6. The dielectric ceramic composition of claim 1, further comprising 0.5 to 4.0 at % of a third accessory ingredient including Si, based on 100 at % of the base material powder.

7. The dielectric ceramic composition of claim 6, wherein the third accessory ingredient includes oxide, carbonate, or glass compound.

8. The dielectric ceramic composition of claim 1, wherein a permittivity of the dielectric ceramic composition is constant with a variable electric field applied thereto.

9. A multilayer ceramic capacitor comprising a ceramic body in which dielectric layers and first and second internal electrodes are alternately stacked,
wherein the dielectric layers contain a dielectric ceramic composition containing a base material powder represented by (Ca₁₋ₓSrₓ)(Zr_{1-y}Ti_{y})O₃ (0≦x≦1.0 and 0.3≦y≦0.8).

10. The multilayer ceramic capacitor of claim 9, wherein the dielectric ceramic composition further contains 0.2 to 4.0 at % of a first accessory ingredient including at least one of Mn, V, Cr, Fe, Ni, Co, Cu, and Zn, based on 100 at % of the base material powder.

11. The multilayer ceramic capacitor of claim 10, wherein the first accessory ingredient includes oxide or carbonate.

12. The multilayer ceramic capacitor of claim 9, wherein the dielectric ceramic composition further contains 4.0 at % or less of a second accessory ingredient including at least one of Y, Dy, Ho, La, Ce, Nd, Sm, Gd, and Er, based on 100 at % of the base material powder.

13. The multilayer ceramic capacitor of claim 12, wherein the second accessory ingredient includes oxide or carbonate.

14. The multilayer ceramic capacitor of claim 9, wherein the dielectric ceramic composition further contains 0.5 to 4.0 at % of a third accessory ingredient including Si, based on 100 at % of the base material powder.

15. The multilayer ceramic capacitor of claim 14, wherein the third accessory ingredient includes oxide, carbonate, or glass compound.

16. The multilayer ceramic capacitor of claim 9, wherein a permittivity of the dielectric ceramic composition is constant with a variable electric field applied thereto.
